(19) United States
(12) Patent Application Publication
(10) Pub. No.: US 2023/0073860 A1
(43) Pub. Date: Mar. 9, 2023

(54) APPARATUS FOR ASSISTING TRAVELLING OF VEHICLE AND METHOD THEREOF

(71) Applicant: HL KLEMOVE CORP., Incheon (KR)

(72) Inventor: Hyunwoo BAEK, Gyeonggi-do (KR)

(21) Appl. No.: 17/938,914

(22) Filed: Sep. 6, 2022

(30) Foreign Application Priority Data
Sep. 9, 2021 (KR) 10-2021-0119956

(51) Int. Cl. B60W 30/095; B60W 50/14; G06V 20/56; G06V 20/58

(52) U.S. Cl. CPC B60W 30/0956; B60W 50/14; G06V 20/588; G06V 20/58; B60W 2420/42; B60W 2554/4041; B60W 2554/4045; B60W 2552/53; B60W 2710/182; B60W 2552/05; B60W 2420/52; B60W 2554/4044; B60W 2554/4042; B60W 2720/10; B60W 2552/10; B60W 2050/146

(57) ABSTRACT

Provided is an apparatus for assisting travelling of a vehicle, the apparatus including: a camera disposed in the vehicle, having a field of view of a front of the vehicle, and acquiring image data; and a controller including a processor for processing the image data, wherein the controller is configured to: identify a lane being travelled on by the vehicle and a preceding vehicle travelling in front of the vehicle based on the image data processed, and in response to the preceding vehicle crossing a center line, generate a control signal for controlling the vehicle based on the preceding vehicle crossing the center line.

### CROSS-REFERENCE TO RELATED APPLICATION

This application is based on and claims priority under 35 U.S.C. § 119 to Korean Patent Application No. 10-2021-0119956, filed on Sep. 8, 2021 in the Korean Intellectual Property Office, the disclosure of which is incorporated herein by reference.

### BACKGROUND

### 1. Field

The disclosure relates to an apparatus for assisting travelling of a vehicle, and more specifically, to an apparatus for assisting travelling of a vehicle by identifying abnormal travelling of a preceding vehicle traveling in front of the vehicle and a method thereof.

### 2. Description of the Related Art

In modern society, vehicles are the most common transportation, and the number of people using vehicles is increasing. The development of vehicle technology leads to ease of long-distance movement and convenience of life, but in some areas having a high population density, such as Korea, road traffic conditions are worsening and traffic congestion becomes serious frequently.

Recently, in order to reduce the burden on the driver and increase convenience, studies are actively conducted on a vehicle equipped with an Advanced Driver Assist System (ADAS) that actively provides information about a vehicle state, a driver state, and a surrounding environment.

Examples of the ADAS mounted on vehicles include a forward collision avoidance (FCA) system, an autonomous emergency brake (AEB) system, a driver attention warning (DAW) system, and the like. Such a system is a system for determining a risk of collision with an object in a travelling situation of a vehicle, and performing collision avoidance and a warning through emergency braking in a collision situation.

However, the conventional technology has a limitation that even when vehicles frequently cross the center line and attempt to turn right at an intersection, the vehicles crossing the center line are excluded from an object that is to be subject to vehicle control, which causes a difficulty in flexibly responding to vehicles abnormally operating, such as crossing the center line.

### SUMMARY

Therefore, it is an object of the disclosure to provide an apparatus for assigning travelling of a vehicle that is capable of identifying a lane being travelled on by the vehicle and an abnormal operation of a preceding vehicle travelling in front of the vehicle, and flexibly coping with the abnormal operation, and a method thereof.

The technical objectives of the disclosure are not limited to the above, and other objectives may become apparent to those of ordinary skill in the art based on the following descriptions.

According to an aspect of the disclosure, there is provided an apparatus for assisting travelling of a vehicle, the apparatus including: a camera disposed in the vehicle, having a field of view of a front of the vehicle, and acquiring image data; and a controller including a processor for processing the image data, wherein the controller is configured to: identify a lane being travelled on by the vehicle and a preceding vehicle travelling in front of the vehicle based on the image data processed, and in response to the preceding vehicle crossing a center line, generate a control signal for controlling the vehicle based on the preceding vehicle crossing the center line.

The controller may be configured to, in response to the preceding vehicle crossing the center line, generate a control signal to secure a brake hydraulic pressure of a braking device of the vehicle.

The controller may be configured to identify an intersection in front of the vehicle based on the image data processed, and in response to a distance between the vehicle and the intersection being less than a predetermined distance, identify that the preceding vehicle crosses the center line.

The apparatus may further include a sensor including at least one of a radar sensor and a Lidar sensor and configured to generate sensing information about the front of the vehicle, wherein the controller may be configured to process the sensing information, and identify the lane being travelled on by the vehicle and the preceding vehicle travelling in front of the vehicle further based on the sensing information processed.

The controller may be configured to identify a traveling direction and a relative velocity of the preceding vehicle based on the image data processed, and generate a control signal for controlling the vehicle based on at least one of the traveling direction and the relative velocity of the preceding vehicle.

The controller may be configured to, in response to the travelling direction of the preceding vehicle being headed toward the lane being travelled on by the vehicle, generate a control signal for controlling the vehicle at a velocity that corresponds to a velocity of the preceding vehicle.

The controller may be configured to, in response to the travelling direction of the preceding vehicle being headed away from the lane being travelled on by the vehicle and a distance between the preceding vehicle and the vehicle becoming greater than a predetermined distance, exclude the preceding vehicle from a preceding vehicle based on which control of the vehicle is performed.

The controller may be configured to, in response to the preceding vehicle crossing the center line, generate a control signal for controlling at least one of a display device and an audio device of the vehicle.

According to another aspect of the disclosure, there is provided a method of assisting travelling of a vehicle, the method including: acquiring, by a camera disposed in the vehicle and having a field of view of a front of the vehicle, image data; identifying a lane being travelled on by the vehicle and a preceding vehicle travelling in front of the vehicle based on the image data processed; and in response to the preceding vehicle crossing a center line, generating a control signal for controlling the vehicle based on the preceding vehicle crossing the center line.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a configuration of a vehicle and a driver assistance system according to an embodiment;

FIG. 2 illustrates a field of view of a camera and a radar included in a driver assistance system according to an embodiment;

FIG. 3 is a conceptual diagram for describing an object identified by a driver assistance system according to an embodiment;

FIG. 4 is a conceptual diagram for describing a vehicle control mechanism of a driver assistance system according to an embodiment;

FIG. 5 is a conceptual diagram for describing a vehicle control mechanism of a driver assistance system according to an embodiment; and

FIG. 6 is a flowchart for describing a vehicle control mechanism of a driver assistance method according to an embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

In the description of an embodiment, it will be understood that, when a member is referred to as being “on/under” another member, it can be directly on/under the other member or one or more intervening members may also be present.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present disclosure will be described with reference to the accompanying drawings.

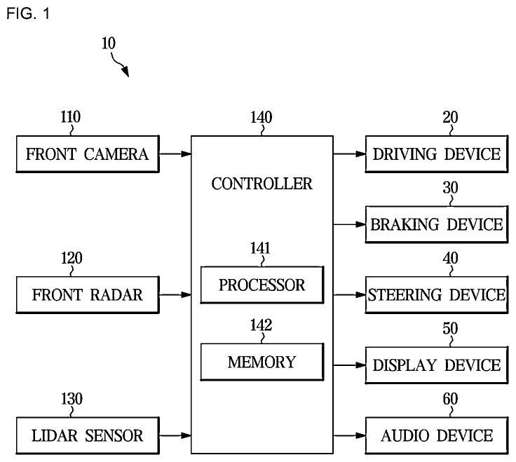

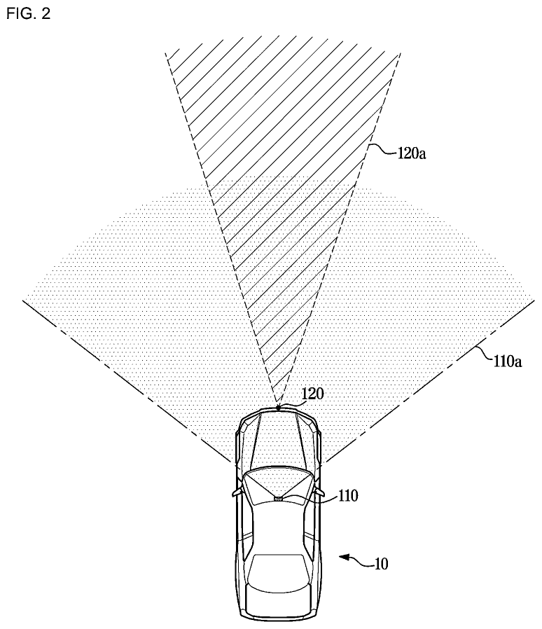

FIG. 1 illustrates a configuration of a vehicle and a driver assistance system according to an embodiment. FIG. 2 illustrates a field of view of a camera and a radar included in a driver assistance system according to an embodiment.

Referring to FIG. 1, a vehicle 10 includes a driving device 20, a braking device 30, a steering device 40, a display device 50, an audio device 60, a front camera 110, a front radar sensor 120, a Lidar sensor 130, and a controller 140. Such components may communicate with each other via a vehicle communication network (NT). For example, the electric devices 20, 30, 40, 50, 60, and 100 included in the vehicle 10 may exchange data therebetween through Ethernet, Media Oriented Systems Transport (MOST), Flexray, Controller Area Network (CAN), Local Interconnect Network (LIN), and the like.

The driving device 140 may be provided to enable the vehicle 1 to move and include, for example, an engine, an engine management system (EMS), a transmission, and a transmission control unit (TCU). The engine may generate power required for the vehicle 10 to travel, and the EMS may control the engine in response to acceleration intent of a driver through an accelerator pedal or a request of the controller 140. The transmission reduces the power generated by the engine and transfers the power to the wheels, and the TCU may control the transmission in response to a shift command of the driver through a shift lever and/or a request of the controller 140.

The braking device 30 may be provided to stop the vehicle 1 and may include, for example, a brake caliper and an electronic brake control module (EBCM). The brake caliper may decelerate the vehicle 10 or stop the vehicle 10 using friction with a brake disc, and the EBCM may control the brake caliper in response to a braking intent of a driver through a brake pedal and/or a request of the controller 140. For example, the EBCM may receive a deceleration request including a deceleration degree from the controller 140 and electrically or hydraulically control the brake caliper to decelerate the vehicle 10 depending on the requested deceleration degree.

The steering device 40 may include an electronic power steering control module (EPS). The steering device 40 may change the travelling direction of the vehicle 1, and the EPS may assist the operation of the steering device 40 such that the driver easily manipulates the steering wheel in response to a steering intent of the driver through the steering wheel. In addition, the EPS may control the steering device in response to a request of the controller 140. For example, the EPS may receive a steering request including a steering torque from the controller 140 and control the steering device to steer the vehicle 1 depending on the requested steering torque.

The display device 50 may include a cluster, a head-up display, a center fascia monitor, and the like, and may provide the driver with various types of information and entertainment through images and sounds. For example, the display device 50 may provide the driver with travelling information of the vehicle 1, information about a route to a destination, a warning message, and the like.

The audio device 60 may include a plurality of speakers, and may provide the driver with various types of information and entertainment through sound. For example, the audio device 60 may provide the driver with travelling information of the vehicle 1, information about a route to a destination, a warning message, and the like.

The front camera 110, the front radar sensor 120, the Lidar sensor 130, and the controller 140 as a whole may assist the travelling of the vehicle. For example, the front camera 110, the front radar sensor 120, the Lidar sensor 130, and the controller 140 as a whole may provide a lane departure warning (LDW), a lane keeping assist (LKA), a high beam assist (HBA), an autonomous emergency braking (AEB), a traffic sign recognition (TSR), an adaptive cruise control (ACC), a blind spot detection (BSD), and the like. However, the present disclosure is not limited thereto.

In another embodiment, the front camera 110, the front radar sensor 120, the Lidar sensor 130, and the controller 140 may be provided separately from each other. For example, the controller 140 may be disposed in a housing separate from a housing of the front camera 110, a housing of the front radar sensor 120, and a housing of the Lidar sensor 130. The controller 140 may exchange data with the front camera 110, the front radar sensor 120, or the Lidar sensor 130 through a wide bandwidth network.

The front camera 110 may have a field of view 110a directed to the front of the vehicle 1 as shown in FIG. 2. The front camera 110 may be disposed, for example, on a front windshield of the vehicle 10. However, the disclosure is not limited thereto.

The front camera 110 may include a plurality of lenses and an image sensor. The image sensor may include a plurality of photodiodes for converting light into electrical signals, and the plurality of photodiodes may be arranged in a two-dimensional matrix.

The front camera 110 may photograph the front of the vehicle 10 and obtain image data of the front of the vehicle 10. The image data of the front of the vehicle 10 may include information about other vehicles, pedestrians, cyclists, or lane lines (markers for distinguishing lanes) positioned in front of the vehicle 10. In addition, the image data of the front of the vehicle 10 may include information about a free space in which the vehicle 10 may travel.

The front camera 110 may be electrically connected to the controller 140. For example, the front camera 110 may be connected to the controller 140 through a vehicle communication network NT, or may be connected to the controller 140 through a hard wire. The front camera 110 may transmit the image data of the front of the vehicle 10 to the controller 140.

The controller 140 may process the image data received from the front camera 110, and identify other vehicles or pedestrians or cyclists or lane lines (markers to distinguish a lane) or a free space located in front of the vehicle 10 from the image data. In particular, the controller 140 may identify a color and a type of a lane line (a marker for distinguishing a lane) of the vehicle 10 based on the processing of the image data. For example, the lane line may include a white dotted line, a white solid line, a double white dotted line, a white double solid line, a yellow dotted line, a yellow solid line, a yellow double dotted line and a yellow double solid line, a blue solid line, and the like. Accordingly, the controller 140 may identify a center line based on the processing of the image data.

The front radar sensor 120 may have a field of sensing 120a directed to the front of the vehicle 10 as shown in FIG. 2. The front radar sensor 120 may be disposed, for example, on a grille or a bumper of the vehicle 10.

The front radar sensor 120 may include a transmission antenna (or a transmission antenna array) that radiates transmission radio waves forward of the vehicle 10 and a reception antenna (or a reception antenna array) that receives reflected radio waves reflected from an object. The front radar sensor 120 may acquire front radar data from the transmission radio waves transmitted by the transmission antenna and the reflection radio waves received by the reception antenna. The radar data may include the relative position and relative velocity of another vehicle, a pedestrian, or a cyclist existing in front of the vehicle 10. The front radar sensor 120 may calculate the relative distance to the object based on the phase difference (or time difference) between the transmission radio waves and the reflected radio waves, and calculate the relative velocity of the object based on the frequency difference between the transmission radio waves and the reflected radio waves.

The front radar sensor 120 may be connected to the controller 140 through a vehicle communication network NT, a hard wire, or a printed circuit board. The front radar sensor 120 may transmit the front radar data to the controller 140.

The controller 140 may process the radar data received from the front radar sensor 120 and identify the relative position and relative velocity of the other vehicles or pedestrians or cyclists positioned in front of the vehicle 10 from the radar data.

The Lidar sensor 130 may have a field of view directed to all directions around the vehicle 10. For example, the Lidar sensor 130 may be disposed, for example, on a roof of the vehicle 10.

The Lidar sensor 130 may include a light source (e.g., a light emitting diode or a light emitting diode array or a laser diode or a laser diode array) that emits light (e.g., infrared light), and a light receiver (e.g., a photodiode or a photodiode array) that receives the light reflected by the object. In addition, when needed, the Lidar sensor 130 may further include a driving device for rotating the light source and the light receiver. During rotation, the Lidar sensor 130 may emit light and receive the light reflected from an object to receive Lidar data. The Lidar data may include the relative positions and relative velocities of other vehicles or pedestrians or cyclists around the vehicle 10.

The Lidar sensor 130 may be connected to the controller 140 through, for example, a vehicle communication network (NT) or a hard wire or a printed circuit board. The Lidar sensor 130 may transmit the Lidar data to the controller 140.

The controller 140 may process the Lidar data received from the Lidar sensor 130, and identify the relative positions and relative velocities of the other vehicles or pedestrians or cyclists located in the vicinity of the vehicle 10 from the Lidar data.

The controller 140 may be electrically connected to the front camera 110, the front radar sensor 120, and the Lidar sensor 130. In addition, the controller 140 may be connected to the driving device 20, the braking device 30, the steering device 40, the display device 50, and the audio device 60 through the vehicle communication network NT.

The controller 140 includes a processor 141 and a memory 142.

The processor 141 may process image data, radar data, and Lidar data, and output a driving signal, a braking signal, a steering signal, and a warning signal for controlling the driving device 20, the braking device 30, the steering device 40, the display device 50, and the audio device 60. For example, the processor 141 may include an image processor, a digital signal processor (DSP), and/or a micro control unit (MCU).

The processor 141 may identify objects (e.g., other vehicles, pedestrians, cyclists, etc.) around the vehicle 10, lane lines of a lane, and a free space based on the image data, the radar data, and the Lidar data.

The processor 141 may acquire the position (the distance from the vehicle and the angle of the travel direction) and type (for example, whether the object is another vehicle or a pedestrian or a cyclist) of the object in front of the vehicle 1 based on the image data. The processor 141 may identify the relative positions and relative velocities of objects in front of the vehicle 10 based on the radar data and the Lidar data. In addition, the processor 141 may match objects identified based on the radar data, objects identified based on the image data, and objects identified based on the Lidar data with each other, and acquire the types, the relative positions, and the relative velocities of the surrounding objects of the vehicle 1 based on a result of the matching.

More specifically, the processor 141 may identify the relative positions and relative velocities of objects in front of and/or around the vehicle 10 based on the radar data and/or the Lidar data. For example, the processor 141 may identify the relative positions of objects located in front of and/or around the vehicle 10 based on the time taken until the radio wave reflected from the object is received and the angle at which the radio wave is received. In addition, the processor 141 may identify the relative velocity of objects in front of and/or around the vehicle 10 based on a change in frequency (Doppler effect) of radio waves reflected from the object.

The processor 141 may estimate the position of the vehicle 10 using a high-definition map (HD map) stored in the memory 142, image data, radar data, and Lidar data. For example, the processor 141 may identify distances to a plurality of landmarks of the HD map based on the Lidar data, and identify an absolute position of the vehicle 10 based on the distances to the plurality of landmarks.

The processor 141 may also project surrounding objects of the vehicle 10 on the HP map based on the image data, the radar data, and the Lidar data. The processor 141 may project surrounding objects of the vehicle 10 on the HP map based on the absolute position of the vehicle 10 and the relative positions of the objects.

The processor 141 may identify a lane (hereinafter referred to as a travelling lane of the vehicle 1) being travelled on by the vehicle and a preceding vehicle travelling in front of the vehicle 10 based on the image data acquired from the camera 110, the radar data acquired from the radar sensor 120, and the Lidar data acquired from the Lidar sensor 130. In other words, based on at least one of the image data, the radar data, and the Lidar data, the processor 141 may identify more accurate information about the travelling lane and the preceding vehicle present in front of the vehicle 10 in proportion to the number of types of data based on which the information is identified.

For example, the processor 141 may more accurately identify data about the preceding vehicle and the travelling lane in proportion to the weight of the type of data (image data, radar data, and Lidar data) to be considered and each sensor.

The processor 141 may identify an abnormal operation of the preceding vehicle based on the identified travelling lane of the vehicle 10 and the identified preceding vehicle travelling in front of the vehicle 10. More specifically, the processor 141 may identify a preceding vehicle travelling in front of the vehicle 10, and determine whether the preceding vehicle crosses the center line. Accordingly, the processor 141 may generate a control signal for controlling the vehicle 10 based on the preceding vehicle crossing the center line.

Here, the control signal for controlling the vehicle 10 may include a signal to control at least one of the driving device 20, the braking device 30, the steering device 40, the display device 50, and the audio device 60.

The processor 141 may, in response to the preceding vehicle traveling in front of the vehicle 10 being identified as crossing the center line based on the data processed, generate a control signal to secure the brake hydraulic pressure of the brake device 30 of the vehicle 10. The securing of the braking hydraulic pressure in advance is a case in which the preceding vehicle operates abnormally, and which is intended to minimize a delay until braking of the vehicle 10 according to the abrupt travelling of the preceding vehicle, but is not limited thereto.

On the other hand, the processor 141 may identify an intersection present in front of the vehicle 10 based on at least one of the image data received from the front camera 110, the radar data received from the radar sensor 120, and the Lidar data received from the Lidar sensor 130, and calculate a distance between the intersection and the vehicle 10. Accordingly, the processor 141 may be provided to identify a preceding vehicle crossing the center line based on the distance between the vehicle 10 and the intersection. This may be to prevent a preceding vehicle from being excluded from the preceding vehicle, based on which the control of the vehicle 10 is performed, when the preceding vehicle crosses the center line to attempt a right turn at the intersection.

In addition, the processor 141 may, in response to the preceding vehicle crossing the center line being identified, identify the travelling direction, relative velocity, and distance to the vehicle 10 of the preceding vehicle, and generate a control signal for controlling the vehicle 10 based on at least one of the travelling direction, relative velocity, and distance to the vehicle 10 of the preceding vehicle.

For example, a preceding vehicle that crosses a center line and operates abnormally is highly likely to have an abrupt change in the travelling route or abrupt braking, and in order to prevent the situation, the processor 141 may be provided to control the vehicle 10 based on the preceding vehicle operating abnormally.

More specifically, when the preceding vehicle crossing the center line is identified, and the distance between the vehicle 10 and the preceding vehicle is greater than a preset distance is a case that there is enough time to respond an abrupt change in travel of the preceding vehicle in advance but a rapid response is required, so the processor 141 may be provided to maintain the hydraulic pressure of the brake secured in advance in response to the preceding vehicle crossing the center line being identified. Here, the preset distance may be, for example, a numerical value applied empirically or experimentally, and for example, may be provided using a user-adaptive variable distance in which the driver may not feel anxious about travelling or a distance in which the braking of the vehicle 10 is ensured within the time to collision with a high reliability. However, the present disclosure is not limited thereto.

In this case, the processor 141 may generate a control signal for controlling the vehicle 10 based on the travelling direction of the preceding vehicle. That is, depending on whether the preceding vehicle operating abnormally is heading in a direction toward the travelling lane of the vehicle 10, or heading in the opposite direction while the distance between the vehicle 10 and the preceding vehicle crossing the center line is greater than the preset distance, the processor 141 may generate a control signal to control the vehicle 10.

That is, the processor 141 may be configured, in response to a case in which the distance between the vehicle 10 and the preceding vehicle crossing the center line is greater than the preset distance but it is determined that the preceding vehicle is heading in a direction toward the travelling lane of the vehicle 1, control the velocity of the vehicle 10 based on the velocity of the preceding vehicle, to thereby secure the safety. In addition, in response to a case in which the preceding vehicle is heading in the opposite direction of the travelling lane of the vehicle 1, the processor 141 may determine that the preceding vehicle has made a left turn, and thus control a control signal to release the secured hydraulic pressure of the brake. However, the present disclosure is not limited thereto.

In another embodiment, the processor 141 may, in response to a case in which the travelling direction of the preceding vehicle is a direction getting away from the travelling lane of the vehicle 10 and the distance between the preceding vehicle and the vehicle 10 becomes greater than the preset distance, exclude the preceding vehicle from a preceding vehicle, based on which the control of the vehicle 10 is performed.

The processor 141 may, for example, based on an angular difference between the travelling direction of the vehicle 10 and the travelling direction of the preceding vehicle, determine whether the preceding vehicle enters or leaves the travelling lane of the vehicle 10. More specifically, the processor 141 may, in a case in which the travelling direction of the preceding vehicle is heading toward the travelling lane of the vehicle 10, and the angular difference between the travelling direction of the vehicle 10 and the travelling direction of the preceding vehicle is greater than a predetermined angle difference, determine that the preceding vehicle enters the travelling lane of the vehicle 10.

In addition, the processor 141 may, in a case in which the travelling direction of the preceding vehicle is not heading toward the travelling lane of the vehicle 10, and the angle difference between the travelling direction of the vehicle 10 and the travelling direction of the preceding vehicle is greater than a predetermined angle difference, determine that the preceding vehicle travels in a direction away from the travelling lane of the vehicle 10. In other words, the processor 141 may determine that the preceding vehicle is making a left turn. However, the present disclosure is not limited thereto. Here, the predetermined angle difference may be, for example, an angle difference for sufficiently identifying a preceding vehicle 200 in a direction opposite to a direction toward the travelling lane of the vehicle 10, but is not limited thereto. That is, the predetermined angle difference may be set experimentally or empirically.

The processor 141 may, when the preceding vehicle crossing the center line is identified and the distance between the vehicle 10 and the preceding vehicle is less than the preset distance, which may be a case in which the vehicle 10 is lacking a remaining time to respond the abrupt travelling of the preceding vehicle, generate a control signal to control the velocity of the vehicle 10 at the longitudinal velocity of the preceding vehicle. Here, the longitudinal direction may refer to a direction parallel to the travelling direction of the vehicle 10, but is not limited thereto.

The processor 141 may generate a control signal for controlling the driving device 20, the braking device 30, the steering device 40, the display device 50, and the audio device 60 of the vehicle 10 based on at least one of the traveling direction and the relative velocity of the preceding vehicle crossing the center line.

The memory 142 may include a program and/or data for the processor 141 to process image data, a program and/or data for the processor 141 to process radar data, and a program and/or data for the processor 141 to generate a driving signal and/or a braking signal and/or a steering signal. In addition, the memory 142 may store a high-precision map.

The memory 142 may temporarily memorize the image data received from the camera 110 and/or the radar data received from the radar sensor 120, and temporarily memorize the processing result of the image data and/or the radar data of the processor 141.

The memory 142 may include not only volatile memories, such as a S-RAM and a D-RAM, but also non-volatile memories, such as a flash memory, a read only memory (ROM), an erasable programmable read only memory (EPROM), etc.

As described above, the controller 140 may transmit a driving signal to the driving device 20, or transmit a braking signal to the braking device 30, or transmit a steering signal to the steering device 40 based on the image data received from the camera 110 and/or the radar data received from the radar sensor 120 and/or the Lidar data received from the Lidar sensor 130.

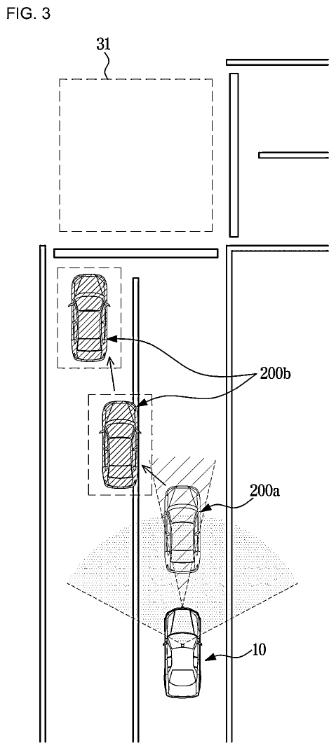

FIG. 3 is a conceptual diagram for describing an object identified by a driver assistance system according to an embodiment.

Referring to FIG. 3, the controller 140 may identify surrounding objects in front of the vehicle 10 based on image data acquired from the camera 110, radar data acquired from the radar sensor 120, and Lidar data acquired from the Lidar sensor 130. The front surrounding objects may include, for example, a preceding vehicle 200a or 200b travelling in front of the vehicle 10, a lane line including a center line, and an intersection 31.

In addition, the controller 140 may determine whether the preceding vehicle 200a travelling in front of the vehicle 10 crosses the identified center line based on at least one of the image data, the radar data, and the Lidar data, and identify the preceding vehicle 200b crossing the center line.

More specifically, the controller 140 may identify object information including the size and wheels of the preceding vehicle 200a, and determine whether a center line crossing of a preceding vehicle occurs based on the object information and the position information of the center line. For example, the controller 140 may, in a case in which the wheel position of the preceding vehicle 200a traveling in front of the vehicle 10 overlaps the position of the center line, determine that the preceding vehicle 200a crosses the center line. However, the present disclosure is not limited thereto.

In another embodiment, the controller 140 may, in a case in which a preset time or longer elapses after the wheel position of the preceding vehicle 200a overlaps the position of the center line, or in a case in which a preset time or longer elapses after the vehicle body of the preceding vehicle 200a is identified as crossing the center line, determine that the preceding vehicle 200a crosses the center line.

Accordingly, the controller 140 may be provided to identify the preceding vehicle 200b, which crosses the center line, and the intersection 31, and generate a control signal for controlling the vehicle 10 based on the identification. In addition, for example, when the preceding vehicle 200b crossing the center line is identified, the controller 140 may generate a control signal to secure the hydraulic pressure of the brake of the vehicle 10.

Meanwhile, the controller 140 may identify a travelling lane of vehicle 10, for example, based on a result of data processed. More specifically, the controller 140 may process image data received from the front camera 110 and based on the image data processed, identify the type of the lane, to thereby identify what number lane is the travelling lane of the vehicle 10. However, the present disclosure is not limited thereto, and the travelling lane of the vehicle 10 may be determined based on determining that the travelling direction of the vehicle travelling in the front left side of the vehicle 10 is opposite to the travelling direction of the vehicle 10.

The controller 140 may identify the travelling lane of the vehicle 10, and in response to the travelling lane of the vehicle being identified as the first lane, identify whether the preceding vehicle 200a traveling in front of the vehicle 10 crosses the center line. However, the present disclosure is not limited thereto.

In another embodiment, the controller 140 may identify an intersection 31 present in front of the vehicle 10, and in response to the distance between the intersection 31 and the vehicle 10 being less than a preset distance, identify whether the preceding vehicle 200a travelling in front of the vehicle 10 crosses the center line.

This is to identify whether the preceding vehicle 200a crosses the center line in response to the vehicle 10 travelling in the first lane, which is a situation having a high possibility of the preceding vehicle 200a abnormally operating, such as crossing a center line, or in response to a presence or absence of an intersection 31 in front of the vehicle 10, thereby providing the apparatus for assisting travelling of a vehicle having a high reliability and high energy efficiency. However, the present disclosure is not limited thereto.

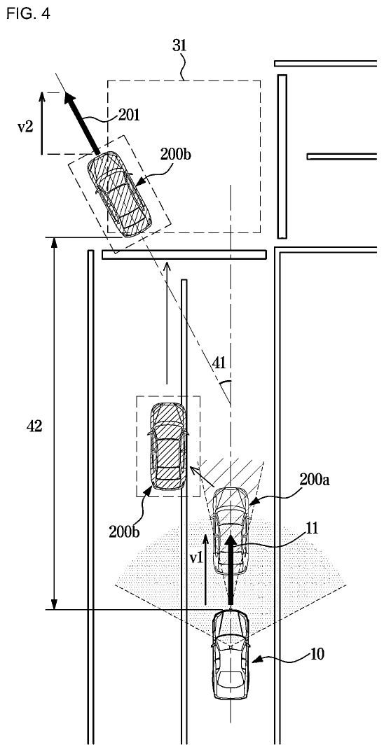

FIG. 4 is a conceptual diagram for describing a vehicle control mechanism of a driver assistance system according to an embodiment.

Referring to FIG. 4, the controller 140 may identify whether the preceding vehicle 200 crosses the center line based on at least one of image data received from the front camera 110, radar data received from the radar sensor 120, and Lidar data received from the Lidar sensor 130, and generate a control signal to control the vehicle 10 based on at least one of a velocity v2 of the identified preceding vehicle 200 crossing the identified center line, a distance 42 between the identified preceding vehicle 200 and the vehicle 10, and a travelling direction 201 of the identified preceding vehicle 200.

More specifically, the controller 140 may, in response to the preceding vehicle 200 crossing the center line being identified, generate a control signal to control the vehicle 10. That is, when a preceding vehicle 200 crossing the center line is present, and a distance 42 between the preceding vehicle 200 and the vehicle 10 is greater than a preset distance is a case in which the vehicle 10 may have enough time to respond an abrupt change in travelling of the preceding vehicle 20, but there is a need to respond to the abrupt change in travelling of the preceding vehicle 200, so the controller 140 may generate a control signal to maintain the hydraulic pressure of the brake secured in advance.

In this case, the controller 140 may generate the control signal of the vehicle 10 based on the travelling direction 201 of the preceding vehicle 200.

That is, as shown in FIG. 4, the controller 140 may, in a case in which the travelling direction 201 of the preceding vehicle 200 crossing the center line is heading in a direction away from the traveling lane of the vehicle 10, and the distance 42 between the preceding vehicle 200 and the vehicle 100 is greater than a preset distance, determine that the preceding vehicle 200 is highly likely to make a left turn, and thus may generate a control signal to release the hydraulic pressure of the brake secured in advance.

On the other hand, the controller 140 may determine that the travelling direction of the preceding vehicle 200 is a direction away from the travelling lane of the vehicle 10 based on the difference between the traveling direction 201 of the preceding vehicle 200 crossing the center line and the travelling direction 11 of the vehicle 10. More specifically, when the angular difference 41 between the travelling direction 201 of the preceding vehicle 200 and the travelling direction 11 of the vehicle 10 is greater than a preset angular difference, the controller 140 may determine that the travelling direction 201 of 200 is a direction away from the travelling lane of the vehicle 10. However, the present disclosure is not limited thereto.

Meanwhile, the controller 140 may, in response to the preceding vehicle 200 crossing the center line being identified, generate a control signal to control the vehicle 10 based on the distance 42 between the preceding vehicle 200 and the vehicle 10. That is, when a preceding vehicle 200 determined as crossing the center line is present, and the distance 42 between the preceding vehicle 200 and the vehicle 10 is less than the preset distance is a case in which the vehicle 10 may not have enough time to respond an abrupt change in travelling of the preceding vehicle 20, so the controller 140 may generate a control signal to control a velocity v1 of the vehicle 10 at a velocity v2 of the preceding vehicle 200. Here, the velocity v2 of the preceding vehicle 200 may represent a longitudinal velocity of the preceding vehicle 200. However, the present disclosure is not limited thereto. In another embodiment, the controller 140 may, only when the velocity v1 of the vehicle 10 is higher than the velocity v2 of the preceding vehicle 200, generate a control signal to control the velocity of the vehicle 10 at the velocity v2 of the preceding vehicle through deceleration control.

In addition, as shown in FIG. 4, in a case in which the distance 42 between the preceding vehicle 200 crossing the center line and the vehicle 10 is smaller than the preset distance and the travelling direction 201 of the preceding vehicle 200 is heading in a direction away from the traveling lane of the vehicle 10, it is expected that the preceding vehicle 200 stably travels when compared to a case in which the distance 42 between the preceding vehicle 200 crossing the center line and the vehicle 10 is smaller than the preset distance, and thus the controller 140 may generate a control signal to deactivate the control of travelling velocity of the vehicle 10. In this case, the controller 140 may, in response to the preceding vehicle 200 not being identified based on the processing of the image data, the radar data, and the Lidar data, generate a control signal to deactivate the control of the travelling velocity v1 of the vehicle 10 while releasing the hydraulic pressure of the brake secured in advance.

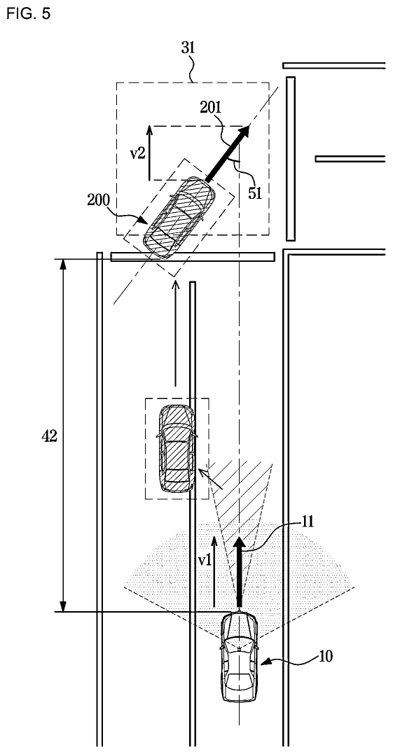

FIG. 5 is a conceptual diagram for describing a vehicle control mechanism of a driver assistance system according to an embodiment.

Referring to FIG. 5, the controller 140 may identify whether the preceding vehicle 200 crosses the center line based on at least one of image data received from the front camera 110, radar data received from the radar sensor 120, and Lidar data received from the Lidar sensor 130, and generate a control signal to control the vehicle 10 based on at least one of a velocity v2 of the identified preceding vehicle 200 crossing the center line, a distance 42 between the identified preceding vehicle 200 and the vehicle 10, and a travelling direction 201 of the identified preceding vehicle 200.

As shown in FIG. 5, when the travelling direction 201 of the preceding vehicle 200 crossing the center line is heading to enter the travelling lane of the vehicle 10 and the distance 42 between the vehicle 10 and the preceding vehicle 200 is greater than a preset distance is a case in which there is enough time for the vehicle 10 to respond an abrupt change in travelling of the preceding vehicle 200, but a collision is expected to occur, so the controller 140 may generate a control signal to control a travelling velocity v1 of the vehicle 10 at a travelling velocity v2 of the preceding vehicle 200.

On the other hand, the controller 140 may determine that the travelling direction of the preceding vehicle 200 is a direction to enter the travelling lane of the vehicle 10 based on the difference between the traveling direction 201 of the preceding vehicle 200 crossing the center line and the travelling direction 11 of the vehicle 10. More specifically, when an angular difference 51 between the travelling direction 201 of the preceding vehicle 200 and the travelling direction 11 of the vehicle 10 is greater than a preset angular difference, the controller 140 may determine that the travelling direction 201 of 200 is a direction to enter the travelling lane of the vehicle 10. However, the present disclosure is not limited thereto.

In addition, as shown in FIG. 5, when the travelling direction 201 of the preceding vehicle 200 crossing the center line is heading to enter the travelling lane of the vehicle 10, and the distance 42 between the vehicle 10 and the preceding vehicles 200 is smaller than the preset distance is a case in which the vehicle 10 may not have enough time to respond an abrupt change in travelling of the preceding vehicle 200, but a collision is highly likely to occur, so the controller 140 may generate a control signal to brake the vehicle 10. However, the present disclosure is not limited thereto.

In another embodiment, in the above case, the controller 140 may generate a control signal to brake the vehicle only when the traveling velocity v1 of the vehicle 10 is higher than the traveling velocity v2 of the preceding vehicle 200.

The controller 140 may identify a free space based on the relative position (the distance and direction) and the relative velocity of the identified object in front of the vehicle 10. For example, the controller 140 may, in response to an object positioned in a lane adjacent to the travelling lane of the vehicle 10 not being identified, identify both the left and right sides of the vehicle 10 as free spaces. The controller 140 may, in response to an object positioned on a front side of the right lane of the travelling lane of the vehicle 10 being identified, identify the left side of the vehicle 10 as a free space. However, the present disclosure is not limited thereto.

The controller 140 may induce the driver to change lanes of the vehicle 10. The controller 140 may control the display device 50 and/or the audio device 60 to induce a lane change of the vehicle 10. Specifically, the controller 140 may transmit a communication message to the display device 50 or the audio device 60 to output an image message and/or a sound message for inducing the driver to perform a lane change of the vehicle 10 as shown in FIG. 5.

The controller 140 may transmit a steering signal for steering toward the free space to the steering device 40 to avoid a collision with an object in front of the vehicle 10. Accordingly, the vehicle 10 may perform a lane change into a lane of the free-space.

That is, the controller 140 may, in a case in which the travelling direction 201 of the preceding vehicle 200 crossing the center line is heading to enter the travelling lane of the vehicle 10 and the distance 42 between the vehicle 10 and the preceding vehicle 200 is less than a preset distance, generate a control signal to change into a lane of o a free-space to avoid a collision with the preceding vehicle 200 in front of the vehicle 10.

Meanwhile, the controller 140 may control the display device 50 and/or the audio device 60 to warn of a collision between the vehicle 10 and the identified front object. Specifically, the controller 140 may transmit a communication message to output an image message and/or a sound message for warning of a collision between the vehicle 10 and the identified forward object.

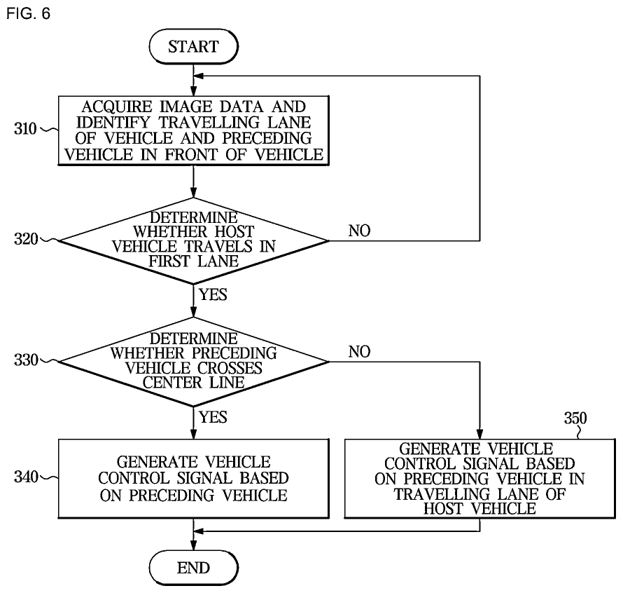

FIG. 6 is a flowchart for describing a vehicle control mechanism of a driver assistance method according to an embodiment.

The driver assistance method illustrated in FIG. 6 may be performed by the controller 140 described above. Accordingly, descriptions of parts of the controller 140, which are omitted below, may be equally applied to the descriptions of the driver assistance method.

Referring to FIG. 6, the controller 140 may acquire image data by the camera 110 disposed in the vehicle 10 and having a field of view of a front of the vehicle 10 (310).

In addition, the controller 140 may generate sensing data regarding the front of the vehicle 10 by at least one of the radar sensor 120 and the Lidar sensor 130 (310).

In addition, the controller 140 may identify the travelling lane of the vehicle 10 and the preceding vehicle 200 travelling in front of the vehicle 10 based on at least one of the image data and the sensing data being processed (310).

The controller 140 may determine whether the travelling lane of the vehicle 10 is the first lane (320).

The controller 140 may, in response to the travelling lane of the vehicle 10 being the first lane, determine whether the preceding vehicle 200 crosses the center line (330).

The controller 140 may, in response to the preceding vehicle 200 crossing the center line, generate a control signal for controlling the vehicle 10 based on the preceding vehicle crossing the center line (340).

In addition, the controller 140 may, in response to the preceding vehicle 200 not crossing the center line, generate a vehicle control signal based on the preceding vehicle 200 in the travelling lane of the vehicle 10 (350).

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random-Access Memory (RAM), a magnetic tape, a magnetic disk, a flash memory, an optical data storage device, and the like.

As is apparent from the above, according to one aspect of the disclosed invention, an apparatus for assisting travelling of a vehicle capable of determining a front congestion section of the vehicle and flexibly coping with various road situations and a method thereof can be provided.

Although embodiments of the present disclosure have been described for illustrative purposes, those skilled in the art will appreciate that various modifications, additions and substitutions are performable, without departing from the scope and spirit of the disclosure. Therefore, embodiments of the present disclosure have not been described for limiting purposes.

What is claimed is:

1. An apparatus for assisting travelling of a vehicle, the apparatus comprising:
a camera disposed in the vehicle, having a field of view of a front of the vehicle, and acquiring image data; and
a controller including a processor for processing the image data,
wherein the controller is configured to:
identify a lane being travelled on by the vehicle and a preceding vehicle travelling in front of the vehicle based on the image data processed, and
in response to the preceding vehicle crossing a center line, generate a control signal for controlling the vehicle based on the preceding vehicle crossing the center line.

2. The apparatus of claim 1, wherein the controller is configured to, in response to the preceding vehicle crossing the center line, generate a control signal to secure a brake hydraulic pressure of a braking device of the vehicle.

3. The apparatus of claim 1, wherein the controller is configured to:
identify an intersection in front of the vehicle based on the image data processed, and
in response to a distance between the vehicle and the intersection being less than a predetermined distance, identify that the preceding vehicle crosses the center line.

4. The apparatus of claim 1, further comprising a sensor including at least one of a radar sensor and a Lidar sensor and configured to generate sensing information about the front of the vehicle,
wherein the controller is configured to:
process the sensing information, and
identify the lane being travelled on by the vehicle and the preceding vehicle travelling in front of the vehicle further based on the sensing information processed.

5. The apparatus of claim 1, wherein the controller is configured to:
identify a traveling direction and a relative velocity of the preceding vehicle based on the image data processed, and
generate a control signal for controlling the vehicle based on at least one of the traveling direction and the relative velocity of the preceding vehicle.

6. The apparatus of claim 5, wherein the controller is configured to, in response to the travelling direction of the preceding vehicle being headed toward the lane being travelled on by the vehicle, generate a control signal for controlling the vehicle at a velocity that corresponds to a velocity of the preceding vehicle.

7. The apparatus of claim 5, wherein the controller is configured to, in response to the travelling direction of the preceding vehicle being headed away from the lane being travelled on by the vehicle and a distance between the preceding vehicle and the vehicle becoming greater than a predetermined distance, exclude the preceding vehicle from a preceding vehicle based on which control of the vehicle is performed.

8. The apparatus of claim 1, wherein the controller is configured to, in response to the preceding vehicle crossing the center line, generate a control signal for controlling at least one of a display device and an audio device of the vehicle.

9. A method of assisting travelling of a vehicle, the method comprising:
acquiring, by a camera disposed in the vehicle and having a field of view of a front of the vehicle, image data;
identifying a lane being travelled on by the vehicle and a preceding vehicle travelling in front of the vehicle based on the image data processed; and
in response to the preceding vehicle crossing a center line, generating a control signal for controlling the vehicle based on the preceding vehicle crossing the center line.

10. The method of claim 9, wherein the generating of the control signal comprises, in response to the preceding vehicle crossing the center line, generating a control signal to secure a brake hydraulic pressure of a braking device of the vehicle.

11. The method of claim 9, wherein the identifying comprises:
based on the image data processed, identifying an intersection in front of the vehicle, and
in response to a distance between the vehicle and the intersection being less than a predetermined distance, identifying that the preceding vehicle crosses the center line.

12. The method of claim 9, further comprising generating, by a sensor including at least one of a radar sensor and a Lidar sensor, generating sensing information about the front of the vehicle,
wherein the identifying comprises processing the sensing information and identifying the lane being travelled on by the vehicle and the preceding vehicle travelling in front of the vehicle further based on the sensing information processed.

13. The method of claim 9, wherein the identifying comprises identifying a traveling direction and a relative velocity of the preceding vehicle based on the image data processed, and
the generating of the control signal comprises generating a control signal for controlling the vehicle based on at least one of the traveling direction and the relative velocity of the preceding vehicle.

14. The method of claim 13, wherein the generating of the control signal comprises, in response to the travelling direction of the preceding vehicle being headed toward the lane being travelled on by the vehicle, generating a control signal for controlling the vehicle at a velocity that corresponds to a velocity of the preceding vehicle.

15. The method of claim 13, wherein the generating of the control signal comprises, in response to the travelling direction of the preceding vehicle being headed away from the lane being travelled on by the vehicle and a distance between the preceding vehicle and the vehicle becoming greater than a predetermined distance, excluding the preceding vehicle from a preceding vehicle based on which control of the vehicle is performed.

16. The method of claim 9, wherein the generating of the control signal comprises, in response to the preceding vehicle crossing the center line, generating a control signal for controlling at least one of a display device and an audio device of the vehicle.

17. A computer-readable recording medium in which a program for executing the method of assisting travelling of the vehicle of claim 9 is recorded.
